(19) United States
(12) Patent Application Publication
(10) Pub. No.: US 2024/0176293 A1
(43) Pub. Date: May 30, 2024

(54) WINDING DEVICE, PARTICULARLY OF A HOROLOGICAL BARREL, FITTED WITH A DISCONNECTABLE RATCHET

(71) Applicant: Nivarox-FAR S.A., Le Locle (CH)

(72) Inventors: Pierre CUSIN, Villars-Burquin (CH); Laurent JEANNERET, Villars-Ie-Lac (FR)

(73) Assignee: Nivarox-FAR S.A., Le Locle (CH)

(21) Appl. No.: 18/497,545

(22) Filed: Oct. 30, 2023

(30) Foreign Application Priority Data
Nov. 24, 2022 (EP) 22209421.1

(51) Int. Cl. G04B 1/20; G04B 9/02

(52) U.S. Cl. CPC G04B 1/20; G04B 9/02

(57) ABSTRACT

A winding device (1), in particular of a barrel (2) provided with a spring, including a ratchet (3) mounted integrally on a rotary winding shaft, the rotary winding shaft being, for example, a winding shaft of the barrel (2), the rotation of which winds the barrel (2), and a winding gear train (4) meshing with the ratchet (3), the rotation of the winding gear train (4) causing the rotation of the ratchet (3) and that of the rotary winding shaft by application of a torque to the ratchet (3), wherein the ratchet is deformable in order to be able to disconnect the ratchet (3) from the winding gear train (4). Also, a horological movement comprising such a winding device (1).

### CROSS-REFERENCE TO RELATED APPLICATIONS

This application claims priority to European Patent Application No. 22209421.1 filed Nov. 24, 2022, the entire contents of which are incorporated herein by reference.

### TECHNICAL FIELD OF THE INVENTION

The invention relates to a winding device, in particular of a horological barrel, fitted with a disconnectable ratchet.

The invention also relates to a horological movement including such a winding device.

### TECHNOLOGICAL BACKGROUND

Most current self-winding mechanical watches generally include an oscillating weight driving a gear train by gravity, the rotation of the drum of which enables a spring blade, the barrel spring, wound in a drum around a rod, to be wound by driving said rod.

However, when the spring is fully wound, it is important to avoid over-winding, which could cause the spring to break, or the oscillator to knock, during which the amplitude of oscillation increases to the point where the balance comes to a stop against the back of the anchor horns, causing the working to drift due to the balance rebounding against these stops.

To avoid these risks, such barrels generally have a system for limiting the winding of the barrel spring.

This limitation is generally achieved by sliding the last outer blade of the spring against the inner wall of the drum. When the spring is fully coiled and wound around the barrel winding shaft, the last coil wound presses against the outer wall of the drum.

Thus, when the winding torque exceeds the friction torque against the wall of the last coil, the latter starts to slide. To prevent uncontrolled sliding, notches allow the end of the blade to stop sliding as soon as the winding torque has dropped sufficiently.

However, the disadvantage of such a system lies in the sliding-friction process of the last coil inside the drum. When the mechanism to be driven requires a high torque, the bearing forces and the friction of the spring blade against the wall are accentuated, leading to wear and a deterioration in the performance of the barrel, even in the presence of grease, which is evacuated from the friction track after a certain time.

Furthermore, in an automatic barrel, it is necessary to meet contradictory criteria to maximise efficiency, such as reduced friction between the coils, and high friction between the spring and the drum to guarantee a good winding torque.

It is furthermore necessary to avoid damage on the drum, such as stripping of the coating, sludge formation, wear on the walls under the pressure of the fully wound spring blade.

### SUMMARY OF THE INVENTION

The aim of the present invention is to overcome all or some of the above-mentioned disadvantages by providing a winding device equipped with a system for limiting the winding of a spring, which replaces a system based on the sliding of a blade against notches in an internal wall of the drum.

To this end, the invention relates to a winding device, in particular for a horological barrel provided with a spring, comprising a ratchet mounted on a rotary winding shaft, the rotary winding shaft being, for example, a barrel winding shaft, the rotation of which winds the barrel, and a winding gear train meshing with the ratchet, the rotation of the winding gear train driving the rotation of the ratchet and that of the rotary winding shaft by the application of a torque to the ratchet.

The invention is remarkable in that the ratchet is deformable so that it can be disconnected from the winding gear train.

Thus, as the ratchet deforms, it is no longer driven by the winding gear train, because the latter no longer meshes with the ratchet. For example, when the torque applied to the ratchet is too high, particularly when the barrel is fully wound, the ratchet deforms and disconnects from the winding gear train, which no longer transmits the rotational torque to the ratchet, so that the winding gear train continues to rotate, but the ratchet no longer rotates.

Thanks to the invention, the risks of premature wear of the barrel are avoided, as the limiting device is arranged upstream from and outside the barrel. In addition, the use of conventional winding limiting devices based on spring friction inside the cylinder is avoided.

According to a particular embodiment of the invention, the ratchet comprises a first peripheral toothing cooperating with a second toothing of the winding gear train, when the torque applied to the ratchet is substantially less than a threshold value.

According to a particular embodiment of the invention, the ratchet deforms when the torque applied to the ratchet substantially exceeds said threshold value, in particular when the barrel is fully wound, such that the first peripheral toothing no longer cooperates with the second toothing.

According to a particular embodiment of the invention, the ratchet comprises a plurality of flexible pawls forming the first toothing of the ratchet, the flexible pawls meshing with the second toothing when the torque is less than the threshold value.

According to a particular embodiment of the invention, the flexible pawls bend when the torque is substantially greater than the threshold value, such that the flexible pawls no longer mesh with the second toothing, the rotation of the winding gear no longer driving the ratchet.

According to a particular embodiment of the invention, the ratchet comprises a hub on which the flexible pawls are arranged, the flexible pawls extending around the hub.

According to a particular embodiment of the invention, each pawl comprises a flexible blade and a tooth arranged at the free end of the flexible blade, the teeth of the flexible pawls cooperating with the second toothing.

According to a particular embodiment of the invention, the flexible pawls are angularly distributed around the ratchet.

According to a particular embodiment of the invention, the ratchet comprises a peripheral rim, preferably rigid, fitted with the first toothing.

According to a particular embodiment of the invention, the ratchet comprises a hub, the peripheral rim being connected to the hub by at least one spring, preferably several connecting springs.

According to a particular embodiment of the invention, the connecting spring(s) contract or stretch when the torque is substantially greater than the threshold value, such that the peripheral rim is moved away from the winding gear train, the rotation of the winding gear train no longer driving the ratchet.

According to a particular embodiment of the invention, the connecting springs are angularly distributed around the hub.

According to a particular embodiment of the invention, the connecting spring(s) are one or more flexible blades.

According to a particular embodiment of the invention, the ratchet is mounted on the barrel, the rotary winding shaft being the barrel winding shaft used to wind the barrel spring.

The invention also relates to a horological movement comprising a barrel, the horological movement including such a barrel winding device.

### BRIEF DESCRIPTION OF THE FIGURES

The aims, advantages and characteristics of the present invention will become apparent on reading several embodiments given solely by way of non-limiting examples, with reference to the appended drawings in which:

FIG. 1 schematically represents a top view of a winding device according to a first embodiment of the invention, in the coupled position,

FIG. 2 schematically represents a top view of the winding device according to the first embodiment of the invention in FIG. 1, in the disconnected position, in particular when the barrel spring is fully wound,

FIG. 3 shows schematically a top view of a winding device according to a second embodiment of the invention, in the coupled position, and

FIG. 4 schematically represents a top view of the winding device according to the second embodiment of the invention in FIG. 3, in the disconnected position, in particular when the barrel spring is fully wound.

### DETAILED DESCRIPTION OF THE INVENTION

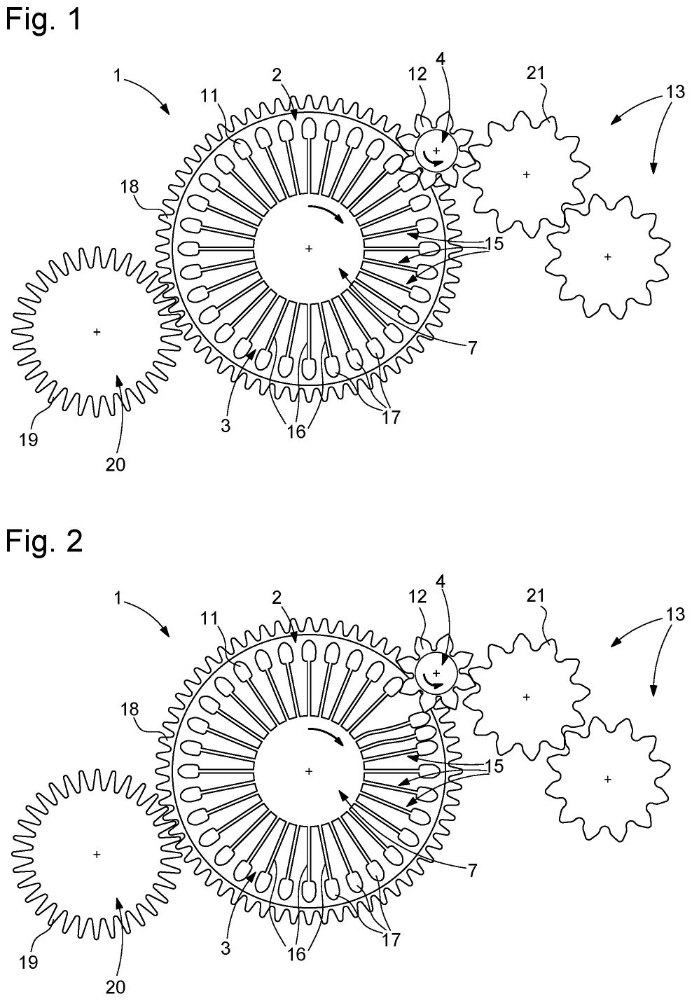

FIGS. 1 and 2 show a first embodiment of a winding device 1, here a horological barrel 2, according to the invention.

The winding device 1 of the barrel 2 comprises a ratchet 3 and a winding gear train 4. The winding gear train 4 meshes with the ratchet 3, such that when the winding gear train 4 is rotated in a first direction, the ratchet 3 is rotated in a second direction opposite to the first direction.

The ratchet 3 is integrally mounted on a winding shaft, the winding shaft enabling the barrel 2 to be wound. The winding shaft is preferably cylindrical.

In the example, the winding shaft is the winding shaft of the barrel 2, the ratchet 3 being arranged on the barrel 2. The ratchet 3 comprises a hub 7 integrally mounted on the winding shaft.

In one variant, not shown in the figures, the winding shaft is not mounted on the barrel, the winding shaft comprising a pinion meshing with a wheel driving the barrel winding shaft to wind the spring, if the ratchet is not mounted on the barrel.

The ratchet 3 comprises a first external toothing 11 distributed around the ratchet 3. The first toothing 11 cooperates with a second toothing 12 arranged on the winding gear train 4. The winding gear train 4, which is for example a pinion in this embodiment, is provided with the second toothing 12 arranged on its periphery.

The barrel 2 comprises a spiral spring (not shown in the figures), arranged inside the barrel 2, which must be wound, either by an automatic winding system, or by a manual winding system.

To this end, the winding device 1 further comprises a gear train system 13, for example driven by an automatic winding weight (not shown in the figures) of the horological movement. The gear train system 13 can also be driven by a winding rod (not shown in the figures) that can be actuated by means of a crown, in the case of manual winding.

A wheel 21 of the gear train system 13 meshes with the second toothing 12 of the winding gear train 4. Thus, by actuating the gear system 13, a torque is applied to the ratchet 4, which transmits it at least in part to the winding shaft via the winding gear train 4 driven by the wheel 21, and via the ratchet 3 driven by the winding gear train 4.

According to the invention, the ratchet 3 is deformable in order to be able to disconnect the ratchet 3 and the winding gear train 4. In particular, the ratchet 3 deforms when the torque applied to the ratchet 3 substantially exceeds a threshold value, in particular when the barrel 2 is fully wound, such that the first peripheral toothing 11 no longer cooperates with the second toothing 12.

To this end, the ratchet 3 comprises a plurality of flexible pawls 15 extending outwards from the hub 7. The flexible pawls 15 are angularly distributed around the hub 7, in the plane of the ratchet 3. The flexible pawls 15 cooperate with the second toothing 12, such that rotation of the winding gear train 4 causes rotation of the ratchet 3, and therefore of the winding shaft, when the barrel 2 is wound.

Each pawl 15 comprises a flexible blade 16 extending from the hub 7 of the ratchet 3. At the free end of each flexible blade 16, there is a tooth 17 capable of cooperating with the second toothing 12 of the winding shaft. The teeth 17 of the pawls 15 form the first toothing 11 cooperating with the second toothing 12. During winding, the teeth 17 of the flexible pawls 15 can be inserted into the first toothing 11 to rotate the ratchet 3.

The disconnecting-gear means 10 preferably comprise at least eight flexible pawls 15, preferably at least fifteen flexible pawls 15. The number of flexible pawls 15 depends on the flexibility of the flexible blades 16, and on the threshold value of the torque above which the disconnecting-gear means 10 are configured to disconnect the ratchet 3 and the winding shaft.

In this embodiment, the ratchet 3 comprises thirty-two flexible pawls 15 distributed around the hub 7 and the winding shaft.

The flexible blades 16 are configured to bend beyond a torque threshold usually required to wind the barrel. Thus, above a threshold value, when the torque is too high, the flexible blades 16 bend, so that the teeth 17 of the flexible pawls 15 retract from the path of the second toothing 12 and the flexible pawls 15 are no longer driven by the second toothing 12.

In other words, when the winding gear train 4 presses hard on one or more flexible pawls 15, the latter bend and move away from the second toothing 12. As a result, the ratchet 3 no longer rotates despite the rotation of the winding gear train 4.

In FIG. 1, in the winding configuration, the winding torque exerted on the ratchet 3, and in particular on the flexible pawls 15, is less than the threshold value, such that the flexible blades 16 of the flexible pawls 15 remain substantially straight. Thus, the flexible pawls 15 and the ratchet 3 are driven by the winding gear train 4. The first peripheral toothing 11 cooperates with a second toothing 12 of the winding gear train 4 when the torque applied to the ratchet 3 is substantially less than a threshold value.

In FIG. 2, when the barrel 2 is fully wound, the winding torque exerted on the ratchet pawls by the winding gear train 4 is greater than the threshold value, such that the flexible blades 16 of the flexible pawls 15 bend. In other words, the torque required to rotate the ratchet 3 is too great for the flexible pawls, which cannot remain straight.

As a result, the teeth 17 of the flexible pawls 15 in contact with the winding gear train 4 are spread apart, with the second toothing 12 of the winding gear train 4 no longer engaging on the first teeth 11, to drive the ratchet 3. The first peripheral toothing 11 no longer cooperates with the second toothing 12. The winding gear train 4 continues to rotate, but the ratchet 3 no longer rotates.

These disconnecting-gear means protect the cylinder 2 from over-winding, and prevent premature wear inside the cylinder 2.

The barrel 2 further comprises a third peripheral toothing 18 configured to cooperate with a fourth toothing 19 of a wheel 20 of the horological movement. The wheel 20 is, for example, a centre wheel or a medium wheel, or even a striking-mechanism wheel. Once wound, the barrel 2 supplies the energy required to operate the horological movement via the wheel 20.

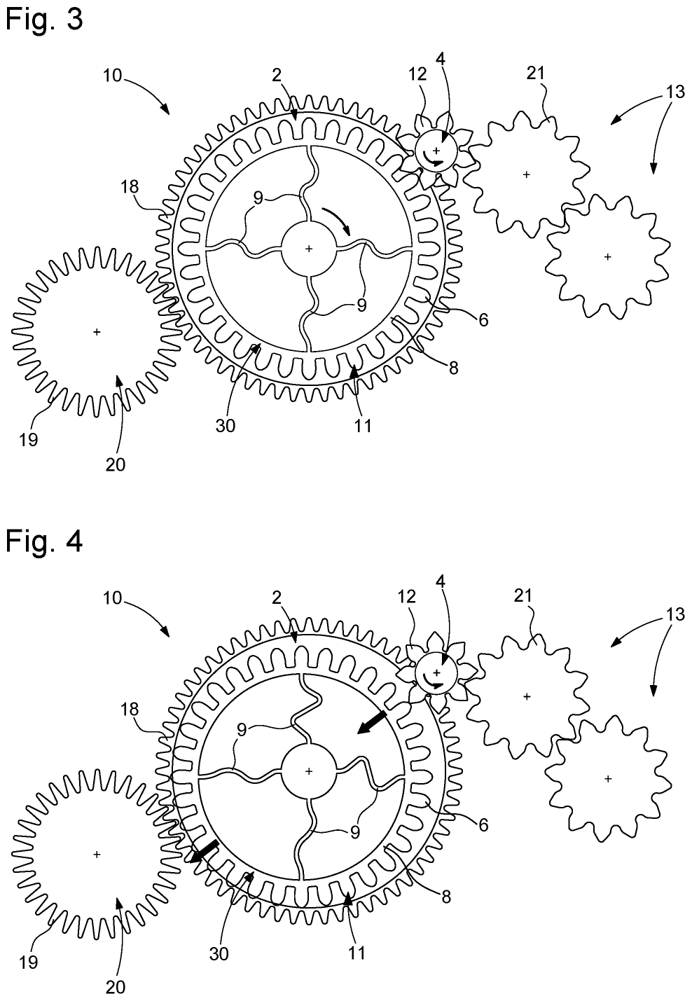

FIGS. 3 and 4 show a second embodiment of a winding device 1, in this case a horological barrel 2, according to the invention.

The winding device 1 of the barrel 2 comprises a ratchet 30 and a winding gear train 4. The winding gear train 4 meshes with the ratchet 30, such that when the winding gear train 4 is rotated in a first direction, the ratchet 30 is rotated in a second direction opposite to the first direction.

The ratchet 30 is integrally mounted on a winding shaft, the winding shaft enabling the barrel 2 to be wound. The winding shaft is preferably cylindrical.

In the example, the winding shaft is the winding shaft of the barrel 2, the ratchet 30 being arranged on the barrel 2. The ratchet 30 comprises a hub 7 integrally mounted on the winding shaft.

In a variant, not shown, the winding shaft is not mounted on the barrel, the winding shaft comprising a pinion meshing with a wheel driving the barrel winding shaft to wind the spring, if the ratchet is not mounted on the barrel.

The ratchet 30 comprises a first external toothing 11 distributed around the ratchet 30. The first toothing 11 cooperates with a second toothing 12 arranged on the winding gear train 4. The winding gear train 4 comprises a pinion provided with the second toothing 12 arranged at its periphery.

The barrel 2 includes a spiral spring (not shown in the figures), arranged inside the barrel 2, which must be wound, either by an automatic winding system, or by a manual winding system.

To this end, the winding device 1 also comprises a gear train system 13, for example driven by an automatic winding weight (not shown in the figures) of the horological movement. The gear train system 13 can also be driven by a winding rod (not shown in the figures) that can be actuated by means of a crown, in the case of manual winding.

A wheel 21 of the gear train system 13 meshes with the second toothing 12 of the winding gear train 4. Thus, by actuating the gear system 13, a torque is applied to the ratchet 4, which transmits it at least in part to the winding shaft via the winding gear train 4 driven by the wheel 21, and via the ratchet 30 driven by the winding gear train 4.

According to the invention, the ratchet 30 is deformable in order to be able to disconnect the ratchet 30 and the winding gear train 4. In particular, the ratchet 30 deforms when the torque applied to the ratchet 30 substantially exceeds a threshold value, in particular when the barrel 2 is fully wound, such that the first peripheral toothing 11 no longer cooperates with the second toothing 12.

To this end, the ratchet 30 comprises a hub 27 and a peripheral rim 8, preferably rigid, the hub 27 being arranged inside the peripheral rim 8. The hub 27 and the peripheral rim 8 have a circular ring shape, the hub 27 having a smaller radius than that of the peripheral rim 8. The hub 27 and the peripheral rim 8 preferably extend in the same plane.

The peripheral rim 8 comprises the first external toothing 11 distributed along the peripheral rim 8 around the ratchet 30.

The hub 27 and the peripheral rim 8 are connected by at least one connecting spring 9, preferably several connecting springs angularly distributed around the hub 27. The connecting spring(s) 9 are, for example, one or more flexible coiled blades.

The number of flexible arms 15 depends on the flexibility of the flexible blades 16, and on the threshold value of the torque beyond which the disconnecting-gear means 10 are configured to disconnect the ratchet 30 and the winding shaft. In this embodiment, the ratchet 30 comprises four connecting springs 9 arranged at the four cardinal points.

The connecting spring(s) 9 are configured to contract or stretch when the torque is substantially greater than the threshold torque value usually required to wind the barrel 2, such that the peripheral rim 8 is moved away from the winding gear train 4.

In other words, when the winding gear train 4 presses hard on the peripheral rim 8, the latter moves away from the second toothing 12.

As a result, the first toothing 11 no longer meshes with the second toothing 12, and the rotation of the winding gear train 4 no longer drives the ratchet 30.

In FIG. 3, in the winding configuration, the winding torque exerted on the ratchet 30 is less than the threshold value, such that the connecting springs 9 do not change shape. Thus, the first toothing 12 and the ratchet 30 are driven by the winding gear train 4.

In FIG. 4, when the barrel 2 is fully wound, the winding torque exerted on the ratchet 30 by the winding gear train 4 is greater than the threshold value, so that the connecting springs 9 contract or extend depending on their arrangement. In other words, the torque required to rotate the ratchet 30 is too great for the connecting springs 9, which cannot remain in their initial shape.

In this example, the two connecting springs 9 arranged on the side of the winding gear train 4 contract, while the two connecting springs arranged on the other side of the hub 27 extend.

As a result, the rim 8 moves away from the winding gear train 4, with the second toothing 12 of the winding gear train 4 no longer engaging on the first teeth 11 to drive the ratchet 30. The winding gear train 4 continues to rotate, but the ratchet 30 no longer rotates.

These disconnecting-gear means protect the barrel 2 from over-winding, and prevent premature wear inside the barrel 2. The winding shaft can thus be locked when the barrel spring is fully wound, without risking breaking the barrel spring 2.

The barrel 2 also comprises a third peripheral toothing 18 configured to cooperate with a fourth toothing 19 of a wheel 20 of the horological movement. The wheel 20 is, for example, a centre wheel or a medium wheel, or even a striking-mechanism wheel. Once wound, the barrel 2 supplies the energy required to operate the horological movement via the wheel 20.

The invention also relates to a horological movement, not shown in the figures, the movement comprising a barrel and a barrel winding device as described above.

Naturally, the invention is not limited to the embodiments described with reference to the figures, and variants could be envisaged without departing from the scope of the invention.

1. A winding device (1, 10) of a barrel (2) provided with a spring, comprising a ratchet (3, 30) integrally mounted on a rotary winding shaft, the rotary winding shaft being a winding shaft of the barrel (2), the rotation of which winds the barrel (2), and a winding gear train (4) meshing with the ratchet (3, 30), rotation of the winding gear train (4) causing rotation of the ratchet (3, 30) and that of the rotary winding shaft by application of a torque to the ratchet (3, 30), wherein the ratchet (3, 30) is deformable in order to be able to disconnect the ratchet (3, 30) from the winding gear (4).

2. The winding device according to claim 1, wherein the ratchet (3, 30) comprises a first peripheral toothing (11) cooperating with a second toothing (12) of the winding gear train (4), when the torque applied to the ratchet (3, 30) is substantially less than a threshold value.

3. The winding device according to claim 2, wherein the ratchet (3, 30) deforms when the torque applied to the ratchet (3, 30) substantially exceeds said threshold value, in particular when the barrel (2) is fully wound, such that the first peripheral toothing (11) no longer cooperates with the second toothing (12).

4. The winding device according to claim 3, wherein the ratchet (3) comprises a plurality of flexible pawls (15) forming the first teeth (11) of the ratchet (3), the flexible pawls (15) meshing with the second teeth (12) when the torque is less than the threshold value.

5. The winding device according to claim 4, wherein the flexible pawls (15) bend when the torque is substantially greater than the threshold value, such that the flexible pawls (15) no longer mesh with the second teeth (12), rotation of the winding gear (4) no longer driving the ratchet (3).

6. The winding device according to claim 4, wherein the ratchet (3) comprises a hub (7) on which the flexible pawls (15) are arranged, the flexible pawls (15) extending around the hub (7).

7. The winding device according to claim 4, wherein each pawl (15) comprises a flexible blade (16) and a tooth (17) arranged at the free end of the flexible blade (16), the teeth (17) of the flexible pawls (15) cooperating with the second toothing (12).

8. The winding device according to claim 4, wherein the flexible pawls (15) are angularly distributed around the ratchet (3).

9. The winding device according to claim 3, wherein the ratchet (30) comprises a peripheral rim (8), preferably rigid, provided with the first toothing (11).

10. The winding device according to claim 9, wherein the ratchet (30) comprises a hub (27), the peripheral rim (8) being connected to the hub (27) by at least one connecting spring (9), preferably several connecting springs.

11. The winding device according to claim 10, wherein the connecting spring(s) (9) contract or stretch when the torque is substantially greater than the threshold value, such that the peripheral rim (8) is moved away from the winding gear train (4), the rotation of the winding gear train (4) no longer driving the ratchet (30).

12. The winding device according to claim 10, wherein the connecting springs (9) are angularly distributed around the hub (27).

13. The winding device according to claim 10, wherein the connecting spring(s) (9) are one or more flexible blades.

14. The winding device according to claim 1, wherein the ratchet (3, 30) is mounted integrally on the barrel (2), the rotary winding shaft being the winding shaft of the barrel (2) enabling the spring of the barrel (2) to be wound.

15. A horological movement comprising the barrel (2) and the winding device (1, 10) for the barrel (2) according to claim 1.
